(19) United States
(12) Patent Application Publication
(10) Pub. No.: US 2002/0163419 A1
(43) Pub. Date: Nov. 7, 2002

(54) Identification system for verifying the authorization to access an object or to use an object such as a motor vehicle

(76) Inventor: Albert Ott, Wiesbaden-Auringen (DE)

Correspondence Address: LERNER AND GREENBERG, P.A, Post Office Box 2480, Hollywood, FL, 33022-2480, US

(21) Appl. No.: 10/106,135

(22) Filed: Mar. 26, 2002

(30) Foreign Application Priority Data
Mar. 26, 2001 (DE) 101 14 876.3

(51) Int. Cl. G05B 19/00

(52) U.S. Cl. 340/5.61; 340/5.21

(57) ABSTRACT

An identification system is provided in which an interrogation signal is transmitted by a transmitting and receiving unit located at an object, and a portable code transmitter transmits a response signal. The interrogation signal and the response signal are alternately transmitted in sections. If, first, code information contained in the response signal is compared and successfully verified with reference information, and second, an overall signal delay time is shorter than a reference code, then an enable signal is produced in order to allow one to access an object or to allow one to use the object.

### BACKGROUND OF THE INVENTION

### FIELD OF THE INVENTION

The invention relates to an identification system for verifying the authorization to access an object or to use the object, which can be in particular a motor vehicle.

Radio-based identification systems, which are also referred to as RF-ID “Radio Frequency Identification” systems, are used increasingly, for example, as a replacement for mechanical key systems, for access protection for computers, and for example, for automatic payment systems. An RF-ID system includes an electronic identification mark (referred to as a code transmitter in the following text), which is also referred to as an electronic key, an RF-ID tag, an ID transmitter or an ID card. The code transmitter is carried by the user or is arranged on an object to be identified. The code transmitter is equipped with a characteristic code (code information). This code is normally interrogated by a base station (referred to as a transmitting and receiving unit in the following text), and is then authenticated or verified. The code can also be sent from the code transmitter to the object when triggered by other triggering mechanisms.

Various radio-based transmission technologies are possible. Radio-based transmission technologies that are normally used include LF systems in the frequency band from 100 to 300 kHz, RF systems at 433 MHz or 867 MHz, and radio-frequency microwave systems, which generally operate at frequencies of 2.4 GHz, 5.8 GHz, 9.5 GHz or 24 GHz.

With regard to code transmitters, a distinction is drawn between active identification and passive identification. Passive identification is distinguished by the fact that the code transmitter can be interrogated at any time, without requiring the user of the transmitting and receiving unit to do anything. If the code transmitter is within a certain distance range of the transmitting and receiving unit, then communication between the transmitting and receiving unit and the code transmitter takes place automatically, or for example, is triggered by the manual operation of a switching device, for example, when the user operates a door catch. The distance range is normally restricted by the radio field attenuation. The transmission of the interrogation signal and the response signal that is triggered in response to the interrogation signal is also referred to as a question and answer dialogue.

In the case of an active identification system, communication is actively initiated by the user of the code transmitter. In this case, the user must normally first manually operate the code transmitter and must then, for example, also operate the door catch, in order to open the door. Passive identification systems are thus being used increasingly, in order to improve convenience.

Identification systems such as these have the disadvantage that the transmission channel can be monitored without being noticed, and in principle, the monitoring can be performed at any time. It is thus normally possible for an attacker to use a suitable device to gain unauthorized access to the code, and thus to overcome the actually desired protection function.

One known identification system (Published German Patent DE 198 36 957 C1), attempts to improve the security against unauthorized use or unauthorized access as a consequence of monitoring of the question and answer dialogue. In this case, the base station transmits a first interrogation signal, whose reception power at the code transmitter is measured. A second interrogation signal is then transmitted in different transmission conditions, and its reception power is likewise measured at the code transmitter. The code information contained in the response signal is evaluated only if the reception powers are different.

In this identification system, the reception powers must be measured at the code transmitter (and also in the base station) before access or use is allowed. Even though this procedure improves the security against unauthorized use or unauthorized access, it requires an expensive code transmitter, of a complex design, as well as a complex base station.

### SUMMARY OF THE INVENTION

It is accordingly an object of the invention to provide an identification system which overcomes the above-mentioned disadvantages of the prior art apparatus of this general type, and which in particular, provides improved security against unauthorized use or unauthorized access.

With the foregoing and other objects in view there is provided, in accordance with the invention, an identification system for verifying authorization, which includes a transmitting and receiving unit that should be configured at an object, for example, on or in a motor vehicle. The identification system includes a control and evaluation unit that is connected to the transmitting and receiving unit for transmitting an interrogation signal and for receiving a response signal having code information. The control and evaluation unit compares the code information in the response signal with reference code information. The control and evaluation unit produces an enable signal for controlling a security appliance if the code information in the response signal at least substantially matches the reference code information. The identification system also includes a mobile code transmitter for receiving the interrogation signal and for transmitting the response signal with the code information in response to receiving the interrogation signal. The code information is characteristic of the mobile code transmitter. The mobile code transmitter can be carried by a user. The interrogation signal and the response signal are each subdivided into a plurality of subsections and are transmitted in sections. A subsection of the response signal is transmitted only when a subsection of the interrogation signal has already been received. A time period from the start of the transmission of a first subsection of the interrogation signal to the end of the reception of the last subsection of the response signal is measured and is compared with a reference period.

In accordance with an added feature of the invention, the enable signal is triggered only when the code information in the response signal that is received, at least substantially matches the reference code information, and when the time period is shorter than the reference period.

In accordance with an additional feature of the invention, the interrogation signal is transmitted at a carrier frequency of either 125 kHz, 433 MHz, or 868 MHz.

In accordance with another feature of the invention, the response signal is transmitted at a carrier frequency of either 125 kHz, 433 MHz, or 868 MHz.

In accordance with a further feature of the invention, the enable signal is for either allowing one to access the object or for allowing one to use the object.

In accordance with a further added feature of the invention, the object is a motor vehicle; and the enable signal is for either allowing one to access the motor vehicle or for allowing one to use the motor vehicle.

In the identification system, a question and answer dialogue is carried out between the object and the code transmitter, with code information being interchanged and verified. So that only one code transmitter in the vicinity of the object can obtain verification of authorization for accessing an object or for using the object, the question and answer dialogue is carried out in sections. The overall time duration of the question and answer dialogue must not exceed a predetermined threshold value. This is the case only when the user, together with the code transmitter, is located in the vicinity of the object. Only then is the code information that is supplied from the code transmitter used to verify the authorization to access an object or to use an object.

Other features which are considered as characteristic for the invention are set forth in the appended claims.

Although the invention is illustrated and described herein as embodied in a identification system for verification of authorization for access to an object or for use of an object, in particular a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows an inventive identification system that is configured in a motor vehicle;

FIG. 2 shows a signal waveform for an interrogation signal and a response signal when using a conventional identification system;

FIG. 3 shows a signal waveform for an interrogation signal and a response signal when using the inventive identification system; and

FIG. 4 shows a comparison of the delay time of the interrogation signal and the response signal in a conventional identification system and of the delay time of the interrogation signal and the response signal in the inventive identification system.

### DESCRIPTION OF THE PREFERRED EMBODIMENTS

The following text explains, in more detail, an identification system for verifying the authorization to access an object or to use an object. As an example, a motor vehicle is used as the object. The identification system can, of course, also be used with other objects, to which access is possible only after verifying authorization, for example, in the case of a computer, a telephone, a cash dispenser, a building, garages, or other areas that are initially barred.

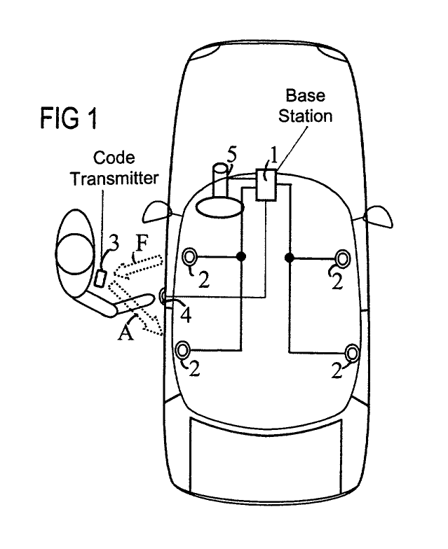

Referring now to the figures of the drawing in detail and first, particularly, to FIG. 1 thereof, there is shown an identification system with a base station 1 (FIG. 1) having a transmitting and receiving unit. This base station 1 is connected to antennas 2, via which the signals can be transmitted and received. The antennas 2 are arranged at exposed points in the motor vehicle, so that signals can be transmitted with sufficient intensity in the interior of the motor vehicle and in an area relatively close to and around the motor vehicle, from where signals can be received sufficiently well.

Security appliances (such as door locks for accessing the motor vehicle or an ignition/steering lock for an immobilizer), not illustrated, for using the motor vehicle are arranged in the motor vehicle, and are likewise connected to the base station 1 via data (bus) and/or control lines. The security appliances are switched to a locked or unlocked state by using a coded enable signal only after verifying the authorization.

Furthermore, the identification system has a mobile, portable code transmitter 3, which itself has a transmitter and a receiver that are not illustrated in the drawing. The code transmitter 3 can receive and transmit signals. Normally it is used to transmit a coded response signal as soon as it has received an interrogation signal (a code transmitter such as this is thus also referred to as a transponder). Authorization for access to or for using the object is verified by using the response signal and the encrypted code information that is contained in the response signal. The code information is compared with reference code information and authorization is verified if they at least substantially match.

In the present identification system, authorization is obtained only when first, the base station 1 receives and also verifies the complete code information, and second, if the code transmitter 3 is located in the vicinity of the motor vehicle when access or use is desired.

According to the invention, the decision as to whether the code transmitter 3 is located in the vicinity of the motor vehicle is made by measuring the time of the entire question and answer dialogue between the motor vehicle and the code transmitter 3, and by comparing this time with a reference period. If the user together with his code transmitter 3 is a long way away from the motor vehicle, then the time period that is required for the question and answer dialogue is too great. When the distance is short, however, the time period is short, and this short distance is desirable when normally operating the identification system.

In the inventive identification system, the question and answer dialogue is carried out in subsections, with parts of the encrypted code information being contained in the subsections. The time measurement does not end until all of the subsections have been received by the base station 1. The complete code information received with the response signal can now be compared with the reference code information.

Transmitting the signals in sections considerably increases the time period in comparison to conventional systems and can, on the one hand, be measured easily and without errors. On the other hand, the measured time period differs considerably from time periods that would be measured for code transmitters 3 located further away, so that a clear boundary can be drawn (threshold value) for distinguishing between code transmitters that are located in the vicinity and code transmitters 3 that are further away.

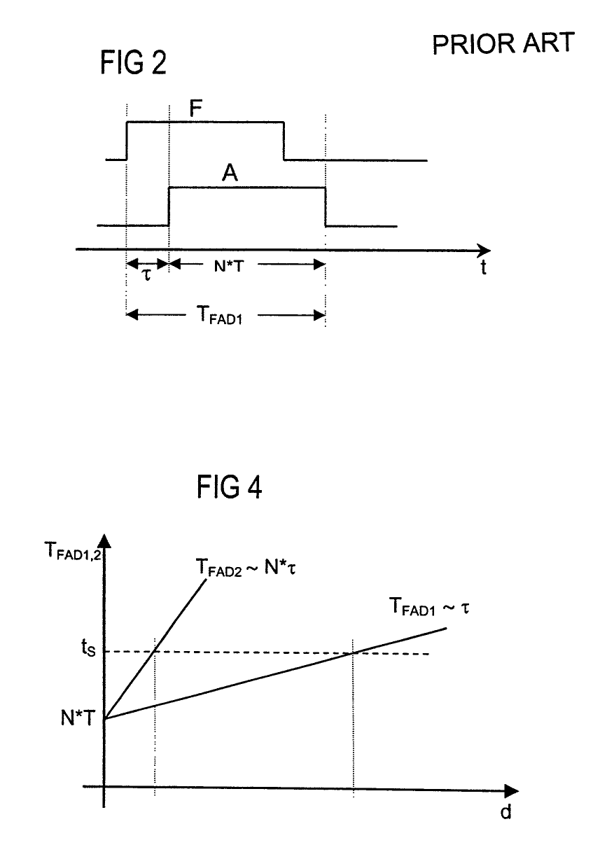

When a user approaches the motor vehicle and operates a door handle or a switch on the motor vehicle, then the question and answer dialogue is initiated, and the time measurement is started. FIG. 2 shows a signal diagram corresponding to a conventional identification system. In the case of conventional identification systems (FIG. 2), the interrogation signal (also referred to as a question F or challenge) is transmitted first of all, triggering a response signal (also referred to as a response A or answer) from the code transmitter 3. After the signal delay τ (delay time for signaling from the base station 1 to the code transmitter 3 and back to the base station 1), the start of the response signal is received by the base station 1. The complete time period for the entire question and answer dialogue corresponds, in conventional identification systems, to the overall time period T_{FAD1}.

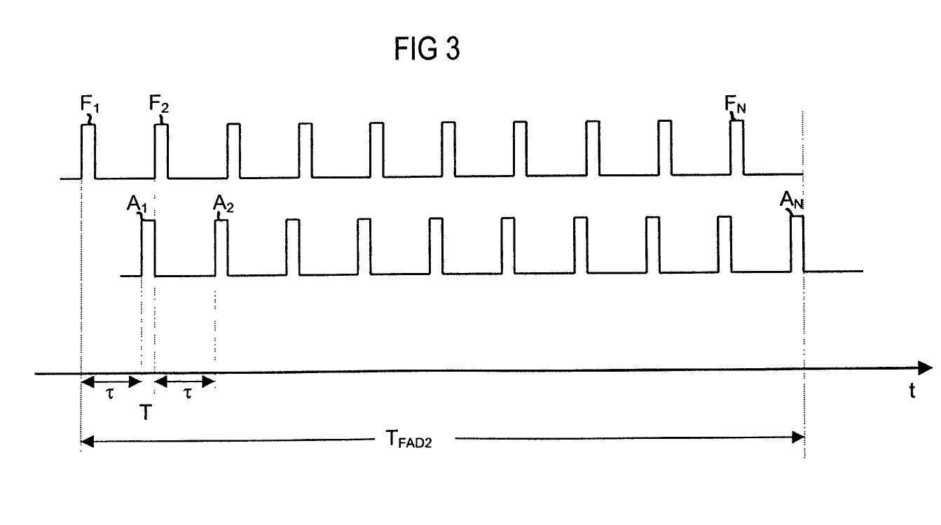

FIG. 3 shows a signal diagram corresponding to the inventive identification system. In the inventive identification system, first a first subsection F₁ of the interrogation signal is transmitted. The code transmitter 3 reacts to this by transmitting a first subsection A₁ of the response signal. Byte groups or bit groups of the signals may be used, by way of example, as the subsections F₁ or A₁, that is to say, one or more bits are transmitted jointly, assuming that the signals are binary coded.

First of all, it is assumed that the question F and the response A each have N bytes (subsections). The question F and the response A may, of course, also have different numbers of bytes, without departing from the principle of the invention.

Each byte requires the time period T for transmission. The interrogation signal in a conventional identification system, thus requires the time period N*T (see FIG. 2). The response signal requires the same time period N*T, but arrives back at the base station 1 with a time delay caused by the signal delay time τ:

$$τ = 2 \cdot \frac{d}{c} + {t}_{0}$$

(where d=distance between the base station 1 and the code transmitter 3, c=speed of light, t₀=signal delay time in the electronic assemblies of the base station 1 and code transmitter). The overall time period for the complete question and answer dialogue thus becomes:

T_{FAD1}=N*T+τ:

(where N=number of bytes and T=time duration of one byte).

Normally, the pure signal delay time in free space=2d/c) is very short in comparison to the time period T. Furthermore, the delay time t₀ in the electronic assemblies is subject to wide tolerances (temperature influences, etc), in the same way as the time period T. In consequence, the simple signal delay time τ cannot be used unambiguously as a decision criterion for an acceptable maximum distance (limiting distance) between the base station 1 and the code transmitter 3 since it varies to a greater or lesser extent, depending on the environmental conditions.

According to the invention, a delay time measurement can be used as a criterion for a limiting distance if the interrogation signal and the response signal are subdivided into subsections Fᵢ, Aᵢ (bytes or bits), and one subsection of the interrogation signal triggers one subsection of the response signal. The next subsection of the interrogation signal is triggered only once the subsection of the response signal has arrived completely at the base station 1. This “interaction” between question and answer is also referred to as a “handshake”.

FIG. 3 shows a signal waveform for an interrogation signal and a response signal, where both signals include N=10 subsections Fᵢ, Aᵢ (i=1 . . . N) in this exemplary embodiment. Once the question and answer dialogue has been initiated, for example, by operating the door handle, the first subsection F₁ of the interrogation signal is transmitted. The associated response A₁ arrives at the base station 1 after the signal delay time τ (starting with the start/rising flank of the first subsection F₁) . The transmission of a pair of subsections is then completed after the signal delay time τ plus the time period T.

The end of the first subsection A₁ of the response signal (which corresponds to the falling signal flank) triggers the transmission of the second subsection F₂ of the interrogation signal. This continues until the last subsection A_{N} of the response signal has arrived completely at the base station 1.

The overall time period T_{FAD2} (also referred to as the interchange time period) required for the complete question and answer dialogue is then:

T_{FAD2}=N*T+N*τ

The overall time periods T_{FAD2} (invention) and T_{FAD1} (conventional identification system) differ essentially by:

T_{FAD2}−T_{FAD1}=(N−1)*τ=(N−1)*(2d/c+t₀),

and hence essentially by the number N of subsections. It is thus clear that the so-called handshake together with the delay time make it possible to create a reliable criterion that can be distinguished clearly, in order to reliably identify whether the code transmitter 3 is or is not in the vicinity of the motor vehicle.

This is explained further by FIG. 4, since FIG. 4 shows, in graphical form, a comparison of the delay time of the interrogation signal and the response signal in a conventional identification system and in the inventive identification system, as a function of the distance d.

The first straight line for the overall time period T_{FAD1} represents the relationship between the overall time period T_{FAD1} for the question and answer dialogue and the distance d between the base station 1 and the code transmitter 3 for a conventional identification system. This straight line is proportional to the signal delay time τ.

The second straight line for the overall time period T_{FAD2} represents the relationship between the overall time period T_{FAD2} for the question and answer dialogue according to the invention and the distance d between the base station 1 and the code transmitter 3. The gradient of this straight line is proportional to the signal delay time N*τ.

If a time threshold tₛ (also referred to as the reference period or reference time period) is now preset, which represents a criterion for the maximum permissible distance d in a realistic manner, then it can be seen that the straight line for the threshold value limit intersects the two straight lines T_{FAD1} and T_{FAD2} at greatly different distances d, and hence at greatly different delay times.

For a realistic time period to be measured at all, there must be a minimum delay time. A relatively long delay time, and hence a long distance, is required for the conventional identification system, while the distance required for the inventive identification system can be considerably shorter.

It is thus simple to preset a limit value for the distance d for the inventive identification system. If a delay time measurement for the overall question and answer dialogue is used to determine that the distance d is greater than is permissible by virtue of the limit value or threshold value tₛ, then the correct code information is not sufficient to verify authorization, either.

The greater the number N of subsections, the more reliably and the more accurately the distance can be determined. However, this results in an increase in the time that the user has to wait before being given authorized access.

Each subsection Aᵢ of the response signal can also be included in the overall code information. In order to provide a sufficiently high level of security against unauthorized monitoring, the code information is subdivided into a number of subsections. The subsections do not all need to contain a part of the code information. It is thus also possible to transmit so-called apparent information in subsections, contributing nothing to the code information.

The number N of subsections in the interrogation signal and in the response signal may be different. For example, only each alternate subsection of the interrogation signal may trigger one such section of the response signal.

The time threshold tₛ can be used to define the maximum distance that the user together with his code transmitter 3 may be from the object. This is because, when a question and answer dialogue having a number of subsections is transmitted, then the overall time period T_{FAD2} for the question and answer dialogue must not exceed the reference period tₛ. If this is nevertheless the case, then it can be assumed that unauthorized manipulation has taken place.

The overall time period T_{FAD2} for the question and answer dialogue can not be indefinitely short, since the minimum time period T_{FADmin}:

T_{FADmin}=N_{F}*T_{A,F}+N*τₘᵢₙ

(where N_{F}, N_{A}=the number of subsections in the question and answer, respectively, T_{F}, T_{A}=the time period for one subsection in the question and answer respectively, and τₘᵢₙ=the minimum delay time when the code transmitter 3 is immediately adjacent to the object) is required in any case for the identification system.

Even if an unauthorized code transmitter 3 were to transmit the response with the code information on a single occasion, then the minimum duration:

T_{FADmin}=N_{F}*T_{F}+N*τₘᵢₙ

will always still remain.

The time periods T_{F}, T_{A} for the subsections of the question and answer need not be equal. The time periods T_{F}, T_{A} may also vary in a predetermined algorithm.

The signals can advantageously be transmitted without using wires both at low carrier frequencies, such as 125 kHz, and at high frequencies, for example at 433 MHz, 868 MHz or 2.4 GHz. However, the frequency at which the interrogation signal and the response signal are transmitted is irrelevant to the invention.

Since high frequency signals have a very much greater range, it becomes all the more important to define a maximum distance d between the base station 1 and the code transmitter 3 within which the code transmitter 3 must be located when designing access or use. Furthermore, with the inventive identification system, this distance can be determined very well and comparably.

The base station 1 can be arranged directly adjacent to one of the antennas 2, or can be arranged centrally. A switch on the outside of the motor vehicle or on the door handle 4 itself may be used as a trigger for the question and answer dialogue. An ignition/starter switch 5 in the motor vehicle can likewise be used as a trigger for the question and answer dialogue, in order to then release the immobilizer (use of the motor vehicle allowed). The threshold value for the overall time period for the question and answer dialogue can then be set such that the code transmitter 3 must undoubtedly be located inside the motor vehicle in order to release the immobilizer—assuming that the code information is correct.

The expression “code transmitter” should be understood as meaning an electronic key or else a so-called ID transmitter which—irrespective of the form of the housing in which it is arranged—is suitable for using an interrogation signal to trigger the transmission of a response signal with encrypted code information to an object. This code information, for example, can be used for authorizing access to an object or for authorizing the ability to use an object. As a more specific example, this code information can be used for authorizing the locking or unlocking of the doors of a motor vehicle or for authorizing the ability to use a motor vehicle.

I claim:

1. An identification system for verifying authorization, comprising:
a transmitting and receiving unit for configuration at an object;
a control and evaluation unit connected to said transmitting and receiving unit for transmitting an interrogation signal and for receiving a response signal having code information, said control and evaluation unit comparing the code information in the response signal with reference code information, said control and evaluation unit producing an enable signal for controlling a security appliance if the code information in the response signal at least substantially matches the reference code information; and
a mobile code transmitter for receiving the interrogation signal and for transmitting the response signal with the code information in response to receiving the interrogation signal, the code information being characteristic of said mobile code transmitter, said mobile code transmitter capable of being carried by a user;
the interrogation signal and the response signal each being subdivided into a plurality of subsections and being transmitted in sections;
a subsection of the response signal being transmitted only when a subsection of the interrogation signal has already been received; and
a time period from a start of transmission of a first subsection of the interrogation signal to an end of reception of a last subsection of the response signal being measured and compared with a reference period.

2. The identification system according to claim 1, wherein the enable signal is triggered only when the code information in the response signal that is received at least substantially matches the reference code information, and the time period is shorter than the reference period.

3. The identification system according to claim 1, wherein the interrogation signal is transmitted at a carrier frequency selected from the group consisting of 125 kHz, 433 MHz, and 868 MHz.

4. The identification system according to claim 3, wherein the response signal is transmitted at a carrier frequency selected from the group consisting of 125 kHz, 433 MHz, and 868 MHz.

5. The identification system according to claim 1, wherein the response signal is transmitted at a carrier frequency selected from the group consisting of 125 kHz, 433 MHz, and 868 MHz.

6. The identification system according to claim 1, wherein the enable signal is for performing a function selected from the group consisting of allowing access to the object and allowing use of the object.

7. The identification system according to claim 1, in combination with the object, wherein:
the object is a motor vehicle; and
the enable signal is for performing a function selected from the group consisting of allowing access to the motor vehicle and allowing use of the motor vehicle.
